(19) United States
(12) Patent Application Publication
(10) Pub. No.: US 2019/0202401 A1
(43) Pub. Date: Jul. 4, 2019

(54) DEVICE AND METHOD FOR CONTROLLING VEHICLE

(71) Applicants: Hyundai Motor Company, Seoul (KR); Kia Motors Corporation, Seoul (KR)

(72) Inventor: Jung Jun Lee, Seoul (KR)

(21) Appl. No.: 15/969,947

(22) Filed: May 3, 2018

(30) Foreign Application Priority Data
Dec. 29, 2017 (KR) 10-2017-0183443

(51) Int. Cl. B60R 25/24; B60R 25/20; B60R 25/01; B60R 25/10; B60R 16/02

(52) U.S. Cl. CPC B60R 25/24; B60R 25/209; B60R 2325/10; B60R 25/10; B60R 16/02; B60R 25/01

(57) ABSTRACT

A device and method for controlling a vehicle can include: a start/stop button configured to receive input corresponding to an engine start operation or an engine stop operation; a door lock/unlock button configured to receive input corresponding to a door lock operation or a door unlock operation; a wireless charger configured to perform wireless charging by magnetic resonance, to transmit an authentication request signal to a smart key, and to receive a response signal from the smart key after transmitting the authentication request signal; and a radio frequency (RF) receiver configured to perform wireless communication with the smart key in an RF band. When transmitting the authentication request signal to the smart key, the wireless charger can adjust a level of the authentication request signal according to the input received at the start/stop button or the input received at the door lock/unlock button.

### CROSS-REFERENCE TO RELATED APPLICATION

This application is based on and claims the benefit of priority to Korean Patent Application No. 10-2017-0183443, filed on Dec. 29, 2017 in the Korean Intellectual Property Office, the disclosure of which is incorporated herein in its entirety by reference.

### TECHNICAL FIELD

The present disclosure relates to vehicular technologies and, more particularly, to a vehicle control device and method for controlling an operation of a vehicle by using a magnetic resonance charging system.

### BACKGROUND

As electronic control technology has been applied to vehicles, techniques for automatically opening/closing doors and starting the engine using a smart key have been developed. The smart key enables a driver to open/close the doors and start the engine even with the smart key in the driver's pocket, thereby maximizing convenience of the driver.

A conventional smart-key system in a vehicle may control engine start and door lock/unlock operations by detecting a smart key (fob) inside the vehicle. In this case, the smart-key system performs smart-key authentication using two low frequency (LF) antennas installed in the vehicle to start the engine and using LF antennas equipped in door handles of the vehicle to lock/unlock doors.

For example, FIG. 1 illustrates a conventional method for controlling a vehicle.

A conventional smart-key system includes a start/stop button or a door lock/unlock button 10, a smart-key controller 20, and a transmitter/receiver 30. Here, the transmitter/receiver 30 includes a low frequency (LF) antenna and a radio frequency (RF) antenna.

When the start/stop button or a door lock/unlock button 10 is operated (input) by a driver, the smart-key controller 20 of the smart-key system detects the operation (input) and drives the LF antenna of the transmitter/receiver 30. The smart-key controller 20 transmits a response request signal for authentication of a smart key 40 to the smart key 40 through the LF antenna. The smart key 40 transmits a response signal through radio frequency (RF) wireless communication. The smart-key controller 20 receives the response signal of the smart key 40 through an RF receiver of the transmitter/receiver 30.

When authentication information contained in the received response signal is valid, the smart key 40 is authenticated. Thus, the smart-key controller 20 can control power, engine start, and door lock/unlock of the vehicle.

### SUMMARY

The present disclosure has been made to solve the above-mentioned problems occurring in the related art while advantages achieved by the related art are maintained intact.

An aspect of the present disclosure provides a vehicle control device and method for controlling vehicle start and door lock/unlock by replacing an existing smart-key system with a magnetic resonance charging system and recognizing a smart key inside or outside a vehicle by dividing wireless charging frequency output into two levels.

The technical problems to be solved by the present disclosure are not limited to the aforementioned problems, and any other technical problems not mentioned herein will be clearly understood from the following description by those skilled in the art to which the present disclosure pertains.

According to embodiments of the present disclosure, a device for controlling a vehicle can include: a start/stop button configured to receive input corresponding to an engine start operation or an engine stop operation; a door lock/unlock button configured to receive input corresponding to a door lock operation or a door unlock operation; a wireless charger configured to perform wireless charging by magnetic resonance, to transmit an authentication request signal to a smart key, and to receive a response signal from the smart key after transmitting the authentication request signal; and a radio frequency (RF) receiver configured to perform wireless communication with the smart key in an RF band. When transmitting the authentication request signal to the smart key, the wireless charger can adjust a level of the authentication request signal according to the input received at the start/stop button or the input received at the door lock/unlock button. Also, the wireless charger can control the engine start operation, the door lock operation, or the door unlock operation based on the response signal received from the smart key.

The wireless charger may transmit the authentication request signal in a low frequency (LF) band used by the smart key.

The wireless charger may include a power supply module that supplies power required for operating the wireless charger, a magnetic resonance transmitter coil that transmits power using magnetic resonance, a source coil that delivers power supplied from the power supply module to the magnetic resonance transmitter coil, and a processor configured to transmit the authentication request signal by driving the magnetic resonance transmitter coil according to the input received at the start/stop button or the input received at the door lock/unlock button.

When transmitting the authentication request signal, the processor may set an output level of the magnetic resonance transmitter coil to a first level in response to detecting the input received at the start/stop button.

The first level may be a signal level indicating that the smart key is located inside the vehicle.

When transmitting the authentication request signal, the processor may set an output level of the magnetic resonance transmitter coil to a first level in response to detecting the input received at the door lock/unlock button, and set the output level of the magnetic resonance transmitter coil to a second level when the wireless charger does not receive the response signal through the RF receiver within a predetermined period of time.

The second level may be a signal level indicating that the smart key is located outside the vehicle.

When transmitting the authentication request signal, the processor may set the output level of the magnetic resonance transmitter coil to the first level in response to detecting the input received at the door lock/unlock button, and output an alarm without performing the door lock operation or the door unlock operation when the wireless charger receives the response signal through the RF receiver within the predetermined period of time.

Furthermore, according to embodiments of the present disclosure, a method for controlling a vehicle can include: detecting, by a wireless charger, input received at a start/stop button corresponding to an engine start operation or an engine stop operation or input received at a door lock/unlock button corresponding to a door lock operation or a door unlock operation; transmitting, by the wireless charger, an authentication request signal to a smart key; adjusting, by the wireless charger, a level of the authentication request signal according to the input received at the start/stop button or the input received at the door lock/unlock button; receiving, by the wireless charger, a response signal from the smart key after transmitting the authentication request signal; and controlling, by the wireless charger, the engine start operation, the door lock operation, or the door unlock operation based on the response signal received from the smart key.

The transmitting of the authentication request signal to the smart key may include: determining whether an operating mode of the wireless charger corresponds to a charging mode when detecting the input received at the start/stop button; temporarily stopping a charging operation when it is determined that the operating mode of the wireless charger corresponds to the charging mode; and adjusting the level of the authentication request signal to a first level after stopping the charging operation.

The transmitting of the authentication request signal to the smart key by adjusting the level of the authentication request signal may further include restarting the charging operation after stopping the charging operation.

The transmitting of the authentication request signal to the smart key may include: adjusting the level of the authentication request signal to a first level in response to detecting the input received at the door lock/unlock button; determining whether the response signal is received from the smart key within a predetermined period of time after transmitting the authentication request signal; and adjusting the level of the authentication request signal to a second level when the response signal is not received.

The adjusting the level of the authentication request signal to the first level may include recognizing the smart key is located inside the vehicle.

The adjusting the level of the authentication request signal to the second level may include recognizing the smart key is located outside the vehicle.

The determining of whether the response signal is received from the smart key within the predetermined period of time may include outputting an ala it without performing the door lock operation or the door unlock operation when the response signal is not received within the predetermined period of time.

According to the present disclosure, vehicle start and door lock/unlock operations may be controlled by replacing an existing smart-key system with a magnetic resonance charging system and recognizing whether a smart key is located inside or outside a vehicle by dividing wireless charging frequency output into two levels. Since the smart key is found without a smart-key unit and an LF antenna as described above, it is possible to reduce cost while maintaining equivalent marketability.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a conventional method for controlling a vehicle;

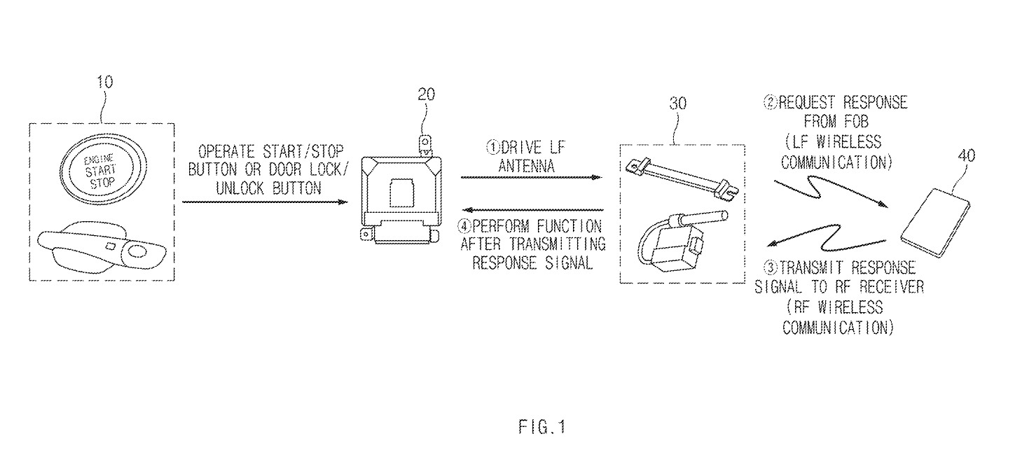

FIG. 2 is a block diagram of a vehicle control device according to embodiments of the present disclosure;

FIG. 3 is a block diagram of a wireless charger illustrated in FIG. 2;

FIG. 4 is a block diagram of a smart key illustrated in FIG. 2;

FIG. 5 is a flowchart illustrating a method for controlling a vehicle, according to embodiments of the present disclosure; and

FIG. 6 is an additional flowchart illustrating a method for controlling a vehicle, according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. The control unit may control operation of units, modules, parts, or the like, as described herein. Moreover, it is understood that the below methods may be executed by an apparatus comprising the control unit in conjunction with one or more other components, as would be appreciated by a person of ordinary skill in the art.

Furthermore, the control unit of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Referring now to the presently disclosed embodiments, the present disclosure relates to a technology for controlling vehicle start and door lock/unlock operations by replacing an existing smart-key system with a magnetic resonance charging system, and recognizing whether a smart key is located inside or outside a vehicle by dividing wireless charging frequency output into two levels. The magnetic resonance charging system is capable of charging a device (e.g., a smartphone, a Bluetooth hands-free device, a tablet computer, or the like) within a short distance (e.g., one to two meters) from the system even though the device is not placed on a charging pad.

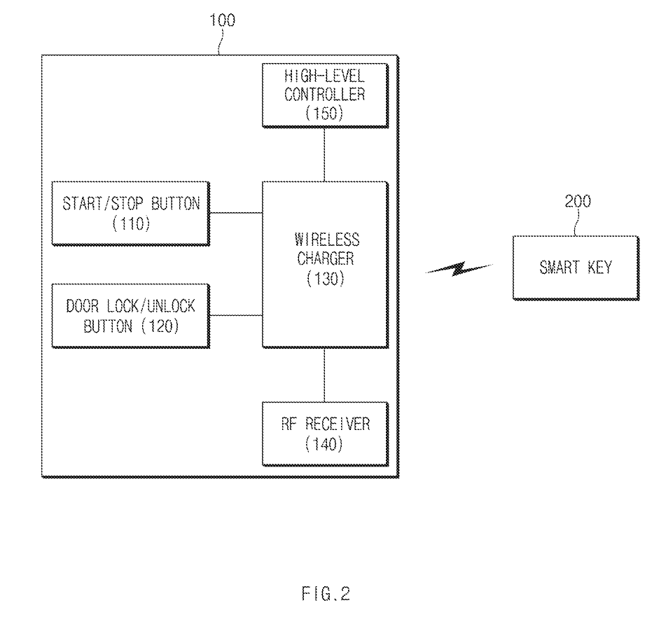

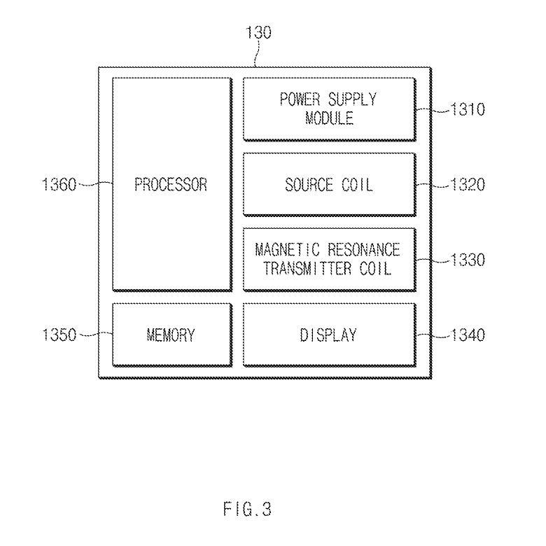

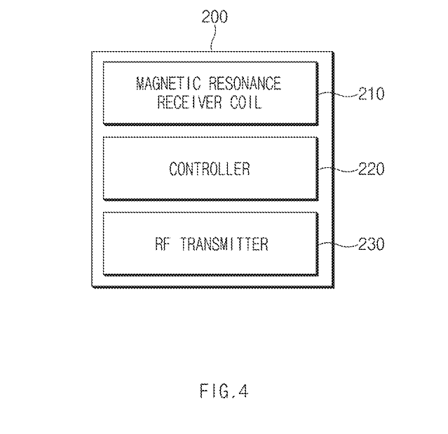

FIG. 2 is a block diagram of a vehicle control device 100 according to embodiments of the present disclosure. FIG. 3 is a block diagram of a wireless charger 130 illustrated in FIG. 2. FIG. 4 is a block diagram of a smart key 200 illustrated in FIG. 2.

The vehicle control device 100 may be installed in a vehicle and may include a start/stop button 110, a door lock/unlock button 120, the wireless charger 130, a radio frequency (RF) receiver 140, and a high-level controller 150, as illustrated in FIG. 2.

The start/stop button 110 may generate an electrical signal in response to a user's operation (input). The start/stop button 110 may be used to select engine start, engine stop, vehicle power-on, vehicle power-off, or accessory power-on (ACC). That is, in response to the user's input, the start/stop button 110 may output any one of an engine start signal, an engine stop signal, a vehicle power-on signal, a vehicle power-off signal, and an accessory power-on signal. The start/stop button 110 may be implemented in the form of a press button, a dial button, or the like.

The door lock/unlock button 120 may be disposed on a door handle of the vehicle and may generate a signal to instruct door lock or door unlock, depending on an operation of the user. The door lock/unlock button 120 may be implemented in the form of a press button switch, a touch button, or the like.

The wireless charger 130 may wirelessly charge a battery of a device to be charged (e.g., a smart key, a mobile terminal, a tablet computer, and/or a notebook computer) by magnetic resonance. In this case, the device to be charged has to be located within a rechargeable distance (several centimeters to several meters) from the wireless charger 130.

The wireless charger 130 may recognize the smart key 200 by setting a wireless charging frequency to a frequency (a low frequency (LF)) of an LF band used by the smart key 200 in wireless communication. Depending on the operation of the start/stop button 110 or the door lock/unlock button 120, the wireless charger 130 may perform an authentication procedure on the smart key 200 inside or outside the vehicle through wireless communication in the LF band.

In other words, when user input is received at the start/stop button 110, the wireless charger 130 may perform smart-key authentication by recognizing the smart key 200 inside the vehicle. In this case, when a signal is input from the start/stop button 110 while the wireless charger 130 is wirelessly charging the battery of the device (not illustrated), the wireless charger 130 may temporarily stop the wireless charging and may perform the smart-key authentication.

Meanwhile, when the door lock/unlock button 120 is input, the wireless charger 130 may attempt authentication (recognition) of the smart key 200 inside the vehicle. When the authentication of the smart key 200 inside the vehicle fails, the wireless charger 130 may perform authentication on the smart key 200 outside the vehicle.

After performing the authentication of the smart key 200, the wireless charger 130 may transmit the authentication result and a vehicle control command to the high-level controller 150. The vehicle control command (vehicle control signal) may include an engine start-on signal, a door lock signal, a door unlock signal, or the like.

The RF receiver 140 may perform wireless communication with the smart key 200 in an RF band (e.g., 433 MHz). The RF receiver 140 may receive, from the smart key 200, a response signal (an RF signal) for an authentication request signal of the wireless charger 130.

The high-level controller 150 may start the vehicle, or may lock or unlock the vehicle door, depending on the smart-key authentication result and the vehicle control command transmitted from the wireless charger 130. The high-level controller 150 may be a hybrid control unit (HCU), an electronic control unit (ECU), or the like.

The high-level controller 150 may perform data communication with the wireless charger 130 through an in-vehicle network. Here, the in-vehicle network may be implemented with a controller area network (CAN), a media oriented systems transport (MOST) network, a local interconnect network (LIN), an x-by-wire (Flexray), or the like.

Referring now to FIG. 3, the wireless charger 130 may include a power supply module 1310, a source coil 1320, a magnetic resonance transmitter coil 1330, a display 1340, a memory 1350, and a processor 1360. Here, the source coil 1320 and the magnetic resonance transmitter coil 1330 may be collectively referred to as a charging coil.

The power supply module 1310 may supply electric power required for operating the wireless charger 130. The power supply module 1310 may generate alternating current.

The source coil 1320 may function to deliver power supplied from the power supply module 1310 to the magnetic resonance transmitter coil 1330.

The magnetic resonance transmitter coil 1330 may generate a magnetic field that vibrates at a specific resonant frequency. The magnetic resonance transmitter coil 1330 may transmit power by using magnetic-field resonance (magnetic resonance).

Also, the magnetic resonance transmitter coil 1330 may perform wireless communication with the smart key 200 in a predetermined LF band. For authentication of the smart key 200, the magnetic resonance transmitter coil 1330 may output an LF signal (i.e., an authentication request signal) to request smart-key authentication. The magnetic resonance transmitter coil 1330 may output the authentication request signal by setting the frequency of the authentication request signal to a frequency of the LF band used by the smart key 200.

The magnetic resonance transmitter coil 1330 may adjust an output level (i.e., a signal level) under the control of the processor 1360. The output level may be divided into a first output level at which the smart key 200 inside the vehicle is detected (recognized) and a second output level at which the smart key 200 located within a predetermined distance from the vehicle is detected.

The display 1340 may display an operating state and a charging state of the wireless charger 130. Here, the operating state may be classified into a charging state and a smart-key authentication state (i.e., a state in which the wireless charger 130 operates as an LF transmitter). The charging state may be classified into charging, the amount of charge, and completion of charging.

The display 1340 may or may not display the charging state, depending on the user's selection. In this case, the display 1340 may receive a user input through an input device (not illustrated) included in the wireless charger 130, or may receive a user input through an input device (not illustrated) included in the vehicle control device 100.

The memory 1350 may store software programmed to cause the processor 1360 to perform predetermined operations and various pieces of setting information. The memory 1350 may also temporarily store data generated based on the operations of the processor 1360.

The memory 1350 may be implemented with at least one of storage mediums (recording mediums), such as a flash memory, a hard disk, a secure digital (SD) card, an random access memory (RAM), a read only memory (ROM), an electrically erasable and programmable ROM (EEPROM), an erasable and programmable ROM (EPROM), a register, a detachable disk, web storage, and the like.

The processor 1360 may control an overall operation of the wireless charger 130. The processor 1360 may include at least one of an application specific integrated circuit (ASIC), a digital signal processor (DSP), programmable logic devices (PLDs), field programmable gate arrays (FPGAs), a central processing unit (CPU), microcontrollers, and microprocessors.

When the processor 1360 receives a signal that the start/stop button 110 or the door lock/unlock button 120 outputs depending on the user's operation, the processor 1360 may drive the magnetic resonance transmitter coil 1330 to transmit a smart-key authentication request signal (an authentication request signal). The processor 1360 may transmit the smart-key authentication request signal by adjusting the output level (the signal level) of the magnetic resonance transmitter coil 1330.

When receiving the signal output from the start/stop button 110, the processor 1360 may transmit the authentication request signal by setting the output level of the magnetic resonance transmitter coil 1330 to a first level. That is, when there is an input received at the start/stop button 110, the processor 1360 may transmit a signal for authentication of the smart key 200 inside the vehicle.

Meanwhile, when there is an input received at the door lock/unlock button 120, the processor 1360 may transmit the authentication request signal by setting the output level of the magnetic resonance transmitter coil 1330 to the first level. When a response signal is not received from the smart key 200 within a predetermined period of time after the first level of authentication request signal is transmitted, the processor 1360 may transmit the authentication request signal by setting the output level of the magnetic resonance transmitter coil 1330 to a second level.

In other words, when there is an input received at the door lock/unlock button 120, the processor 1360 may transmit a signal for recognizing (authenticating) the smart key 200 inside the vehicle. When the smart key 200 inside the vehicle is recognized, the processor 1360 may output an alert through an output device. The output device may output visual information, auditory information, and/or tactile information. The output device may include a display, an audio output module, and/or a haptic module. When the smart key 200 is not recognized inside the vehicle, the processor 1360 may recognize the smart key 200 outside the vehicle.

After transmitting the authentication request signal through the magnetic resonance transmitter coil 1330, the processor 1360 may receive a response signal transmitted from the smart key 200 through the RF receiver 140. The smart key 200 may transmit the response signal containing authentication information. Here, the authentication information may include identification information of the smart key 200, such as a personal identification number (PIN), and information representing whether the smart key 200 is authenticated or not.

When there is no response from the smart key 200 within a predetermined period of time after the smart-key authentication request signal is transmitted, the processor 1360 may determine that the smart key 200 is not present in the corresponding area (the indoor area or the outdoor area). When the response signal is received from the smart key 200 within the predetermined period of time after the smart-key authentication request signal is transmitted, the processor 1360 may determine that the smart key 200 is present in the corresponding area (the indoor area or the outdoor area).

The processor 1360 may determine whether the authentication information contained in the received response signal is valid, and may perform vehicle control depending on the determination result. For example, when it is determined that the authentication information of the smart key 200 is valid, the processor 1360 may transmit an engine start-on signal to the high-level controller 150 to start the engine, or may transmit a door lock signal or a door unlock signal to the high-level controller 150.

When the smart-key authentication request signal is received from the vehicle control device 100, the smart key 200 may transmit a response signal for the authentication request. The smart key 200 may include a magnetic resonance receiver coil 210, a controller 220, and an RF transmitter 230, as illustrated in FIG. 4.

The magnetic resonance receiver coil 210 may receive the smart-key authentication request signal transmitted from the magnetic resonance transmitter coil 1330 of the vehicle control device 100. That is, the magnetic resonance receiver coil 210 may receive the LF signal (i.e., the smart-key authentication request signal) transmitted from the vehicle control device 100.

When the controller 220 receives the authentication request signal through the magnetic resonance receiver coil 210, the controller 220 may generate and output a response signal for the authentication request signal. The controller 220 may generate a response signal containing authentication information of the smart key 200.

The RF transmitter 230 may transmit the response signal through RF wireless communication under the control of the controller 220. In other words, the RF transmitter 230 may transmit the response signal containing the authentication information, which is output from the controller 220, as an RF signal.

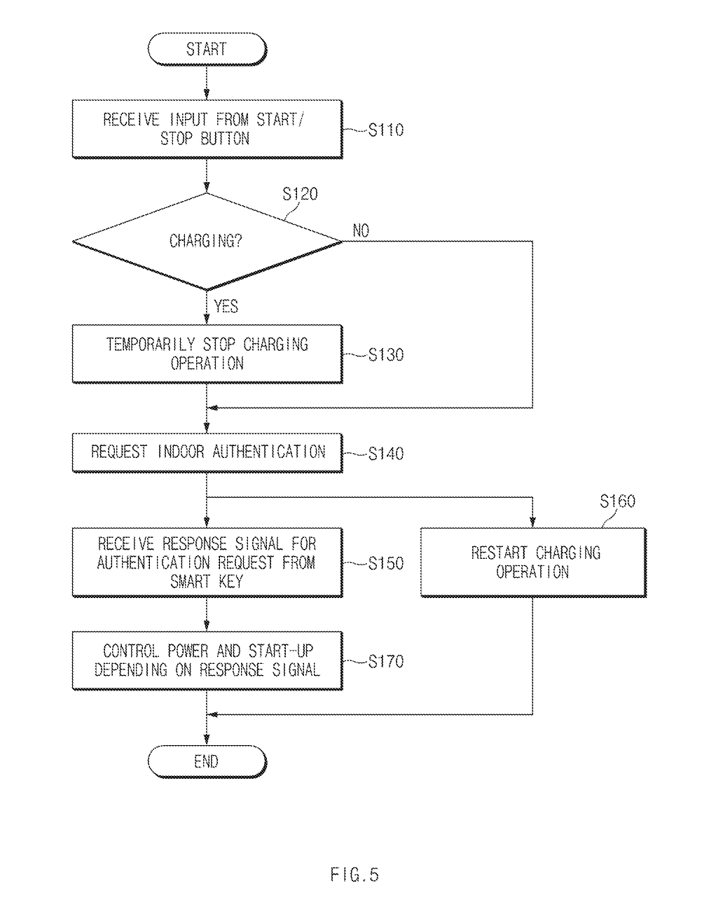

FIG. 5 is a flowchart illustrating a method for controlling a vehicle, according to embodiments of the present disclosure.

As illustrated in FIG. 5, the wireless charger 130 may detect an operation of the start/stop button 110 (Step S110). For example, when a user presses the start/stop button 110, the start/stop button 110 may generate an electrical signal corresponding thereto. When the wireless charger 130 receives the electrical signal generated by the start/stop button 110, the wireless charger 130 may detect that the start/stop button 110 is operated.

When detecting the operation of the start/stop button 110, the wireless charger 130 may determine whether an operating mode of the wireless charger 130 corresponds to a charging mode (Step S120). Here, the operating mode may be classified into a charging mode and a smart-key authentication mode. When detecting the input received at the start/stop button 110, the wireless charger 130 may determine whether the wireless charger 130 is wirelessly charging a battery of a device to be charged (not illustrated). The wireless charger 130 may display the operating mode through the display 1340 to allow the user (e.g., driver) to recognize the operating mode of the wireless charger 130. In this case, the display 1340 may output information, such as a charging state, completion or not of charging, and the like, in the form of text, an image, and/or a symbol.

In the case where the wireless charger 130 is performing wireless charging, the wireless charger 130 may temporarily stop the charging operation (Step S130). The wireless charger 130 may stop transmitting a wireless charging frequency (an LF signal) through the charging coils 1320 and 1330. That is, the wireless charger 130 may stop charging the battery of the target device for a predetermined period of time by stopping supply of wireless power.

The wireless charger 130 may request authentication of a smart key inside a vehicle by driving the charging coils 1320 and 1330 (Step S140). The wireless charger 130 may transmit a smart-key authentication request signal as an LF signal by driving the charging coils 1320 and 1330. In this case, the wireless charger 130 may control the magnetic resonance transmitter coil 1330 to match the frequency of the smart-key authentication request signal and a frequency of an LF band used by the smart key 200. Also, the wireless charger 130 may output the LF signal (i.e., the authentication request signal) by adjusting the output level of the magnetic resonance transmitter coil 1330 to a first level.

The wireless charger 130 may receive, from the smart key 200, a response signal for the authentication request (Step S150). The smart key 200 may transmit the response signal containing authentication information of the smart key 200 as an RF signal.

When the authentication request for the smart key 200 inside the vehicle is completed, the wireless charger 130 may restart the suspended charging operation (Step S160). In this case, the wireless charger 130 may restart the charging operation when a predetermined period of time (e.g., two seconds) elapses after the completion of the smart-key authentication request. In other words, the wireless charger 130 may transmit wireless power through the charging coils.

The wireless charger 130 may control vehicle power and engine start/stop operations, based on the response signal from the smart key 200 (Step S170). The wireless charger 130 may receive the response signal transmitted from the smart key 200 through the RF receiver 140. The wireless charger 130 may determine whether the authentication information contained in the received response signal is valid. When it is determined that the authentication information is valid, the wireless charger 130 may control vehicle power and engine start operations. In contrast, when it is determined that the authentication information is not valid, the wireless charger 130 may output an alert sound and/or an alert message in the form of visual and/or auditory information through an output device (not illustrated) and may interrupt (i.e., not perform) vehicle power and engine start control.

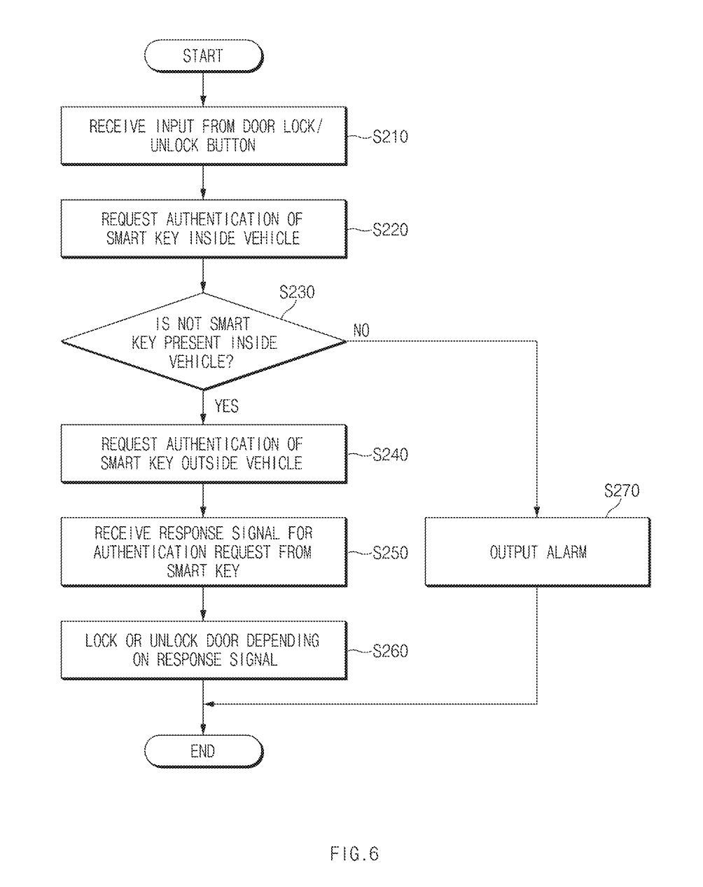

FIG. 6 is an additional flowchart illustrating a method for controlling a vehicle, according to embodiments of the present disclosure.

As illustrated in FIG. 6, the wireless charger 130 may receive an input from the door lock/unlock button 120 (Step S210). The wireless charger 130 may receive a signal that the door lock/unlock button 120 generates depending on a user's operation.

When there is an input from the door lock/unlock button 120, the wireless charger 130 may request authentication of a smart key inside a vehicle (Step S220). The processor 1360 of the wireless charger 130 may set the output level of the magnetic resonance transmitter coil 1330 to a first level and may transmit a smart-key authentication request signal through the magnetic resonance transmitter coil 1330.

The wireless charger 130 may determine whether the smart key 200 is not present inside the vehicle, depending on whether the authentication of the smart key inside the vehicle succeeds or not (Step S230). When the wireless charger 130 does not receive a response signal from the smart key 200 within a predetermined period of time after transmitting the smart-key authentication request signal, the wireless charger 130 may determine that the smart key 200 is not present inside the vehicle. In contrast, when a response signal of the smart key 200 for the smart-key authentication request is received within the predetermined period of time, the wireless charger 130 may determine that the smart key 200 is present inside the vehicle.

In the case where the smart key 200 is not present inside the vehicle, the wireless charger 130 may request authentication of a smart key outside the vehicle (Step S240). The processor 1360 of the wireless charger 130 may set the output level of the magnetic resonance transmitter coil 1330 to a second level and may transmit a smart-key authentication request signal through the magnetic resonance transmitter coil 1330.

The wireless charger 130 may receive a response signal for the authentication request from the smart key 200 after transmitting the smart-key authentication request signal (Step S250). The smart key 200 may transmit a response signal containing authentication information of the smart key 200 as an RF signal.

The wireless charger 130 may perform door lock or door unlock operations, depending on the response signal (Step S260). The wireless charger 130 may determine whether the authentication information contained in the received response signal is valid, and when it is determined that the authentication information is valid, the wireless charger 130 may control door lock or unlock of the vehicle.

Meanwhile, when it is determined in step S230 that the smart key 200 is present inside the vehicle, the wireless charger 130 may output an alarm (Step S270). In this case, the wireless charger 130 may not perform door lock and door unlock operations.

In the above-described embodiments of the present disclosure, all of the elements are combined to operate as a single system, but the present disclosure is not limited thereto. In order words, some of the elements may be selectively combined to operate within the scope of the present disclosure. In addition, all of the elements may be provided as independent hardware devices, or part or all of the elements may be selectively combined to configure a computer program having program modules performing part or all of functions in a single or a plurality of hardware devices. Codes and code segments constituting the computer program may easily be inferred by a person skilled in the art. In addition, the computer program may be stored in a computer-readable medium and may be read and executed by a computer, thereby implementing the embodiments of the present disclosure.

While the contents of the present disclosure have been described in connection with what is presently considered to be exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A device for controlling a vehicle, the device comprising:
a start/stop button configured to receive input corresponding to an engine start operation or an engine stop operation;
a door lock/unlock button configured to receive input corresponding to a door lock operation or a door unlock operation;
a wireless charger configured to perform wireless charging by magnetic resonance, to transmit an authentication request signal to a smart key, and to receive a response signal from the smart key after transmitting the authentication request signal; and
a radio frequency (RF) receiver configured to perform wireless communication with the smart key in an RF band, wherein
when transmitting the authentication request signal to the smart key, the wireless charger adjusts a level of the authentication request signal according to the input received at the start/stop button or the input received at the door lock/unlock button, and
the wireless charger controls the engine start operation, the door lock operation, or the door unlock operation based on the response signal received from the smart key.

2. The device of claim 1, wherein the wireless charger transmits the authentication request signal in a low frequency (LF) band used by the smart key.

3. The device of claim 1, wherein the wireless charger includes:
a power supply module configured to supply power required for operating the wireless charger;
a magnetic resonance transmitter coil configured to transmit power using magnetic resonance;
a source coil configured to deliver power supplied from the power supply module to the magnetic resonance transmitter coil; and
a processor configured to transmit the authentication request signal by driving the magnetic resonance transmitter coil according to the input received at the start/stop button or the input received at the door lock/unlock button.

4. The device of claim 3, wherein, when transmitting the authentication request signal, the processor sets an output level of the magnetic resonance transmitter coil to a first level in response to detecting the input received at the start/stop button.

5. The device of claim 4, wherein the first level is a signal level indicating that the smart key is located inside the vehicle.

6. The device of claim 3, wherein, when transmitting the authentication request signal, the processor sets an output level of the magnetic resonance transmitter coil to a first level in response to detecting the input received at the door lock/unlock button, and sets the output level of the magnetic resonance transmitter coil to a second level when the wireless charger does not receive the response signal through the RF receiver within a predetermined period of time.

7. The device of claim 6, wherein the second level is a signal level indicating that the smart key is located outside the vehicle.

8. The device of claim 6, wherein, when transmitting the authentication request signal, the processor sets the output level of the magnetic resonance transmitter coil to the first level in response to detecting the input received at the door lock/unlock button, and outputs an alarm without performing the door lock operation or the door unlock operation when the wireless charger receives the response signal through the RF receiver within the predetermined period of time.

9. A method for controlling a vehicle, the method comprising:
detecting, by a wireless charger, input received at a start/stop button corresponding to an engine start operation or an engine stop operation or input received at a door lock/unlock button corresponding to a door lock operation or a door unlock operation;
transmitting, by the wireless charger, an authentication request signal to a smart key;
adjusting, by the wireless charger, a level of the authentication request signal according to the input received at the start/stop button or the input received at the door lock/unlock button;
receiving, by the wireless charger, a response signal from the smart key after transmitting the authentication request signal; and
controlling, by the wireless charger, the engine start operation, the door lock operation, or the door unlock operation based on the response signal received from the smart key.

10. The method of claim 9, wherein the transmitting of the authentication request signal to the smart key includes:
determining whether an operating mode of the wireless charger corresponds to a charging mode when detecting the input received at the start/stop button;
temporarily stopping a charging operation when it is determined that the operating mode of the wireless charger corresponds to the charging mode; and
adjusting the level of the authentication request signal to a first level after stopping the charging operation.

11. The method of claim 10, wherein the transmitting of the authentication request signal to the smart key further includes:
restarting the charging operation after stopping the charging operation.

12. The method of claim 9, wherein the transmitting of the authentication request signal to the smart key includes:
adjusting the level of the authentication request signal to a first level in response to detecting the input received at the door lock/unlock button;
determining whether the response signal is received from the smart key within a predetermined period of time after transmitting the authentication request signal; and
adjusting the level of the authentication request signal to a second level when the response signal is not received.

13. The method of claim 12, wherein the adjusting the level of the authentication request signal to the first level includes:
recognizing the smart key is located inside the vehicle.

14. The method of claim 12, wherein the adjusting the level of the authentication request signal to the second level includes:
recognizing the smart key is located outside the vehicle.

15. The method of claim 12, wherein the determining of whether the response signal is received from the smart key within the predetermined period of time includes:
outputting an alarm without performing the door lock operation or the door unlock operation when the response signal is not received within the predetermined period of time.
